(19) United States
(12) Patent Application Publication
(10) Pub. No.: US 2021/0342765 A1
(43) Pub. Date: Nov. 4, 2021

(54) INFORMATION PROCESSING APPARATUS, SERVICE INTEGRATED SYSTEM, AND NON-TRANSITORY COMPUTER-EXECUTABLE MEDIUM

(71) Applicant: Ricoh Company, Ltd., Tokyo (JP)

(72) Inventor: Yuuki OHTAKA, Kanagawa (JP)

(73) Assignee: Ricoh Company, Ltd., Tokyo (JP)

(21) Appl. No.: 17/231,196

(22) Filed: Apr. 15, 2021

(30) Foreign Application Priority Data
Apr. 30, 2020 (JP) 2020-080816

(51) Int. Cl. G06Q 10/06; H04L 29/06

(52) U.S. Cl. CPC G06Q 10/06315; H04L 63/102; H04L 63/083

(57) ABSTRACT

An information processing apparatus includes circuitry configured to identify a particular data item as a basis for aggregation of a report to be output, based on aggregation basis information that indicates one or more data items usable as bases for aggregating data to be contained in the report, among data available to a user. The data available to the user are identified based on service contract information that indicates one or more services available to the user and data definition information that indicates data generated for each of the one or more services. The circuitry is further configured to output the report aggregated using the identified particular data item as the basis.

### CROSS-REFERENCE TO RELATED APPLICATION

This patent application is based on and claims priority under 35 U.S.C. § 119(a) to Japanese Patent Application No. 2020-080816, filed on Apr. 30, 2020, in the Japan Patent Office, the entire disclosure of which is incorporated herein by reference.

### BACKGROUND

### Technical Field

Embodiments of the present disclosure relate to an information processing apparatus, a service integrated system, and a non-transitory computer-executable medium.

### Related Art

A system implementing a business model called software as a service (SaaS) is developed, in which software operates on a provider's computer, and users uses the functions of the software as a service via a network such as the Internet, and pay a service charge.

### SUMMARY

According to an embodiment, an information processing apparatus includes circuitry configured to identify a particular data item as a basis for aggregation of a report to be output, based on aggregation basis information that indicates one or more data items usable as bases for aggregating data to be contained in the report, among data available to a user. The data available to the user are identified based on service contract information that indicates one or more services available to the user and data definition information that indicates data generated for each of the one or more services. The circuitry is further configured to output the report aggregated using the identified particular data item as the basis.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a configuration of a service integrated system, according to an embodiment of the present disclosure;

FIG. 2 is a block diagram illustrating an example of a hardware configuration of a report server of the service integrated system illustrated in FIG. 1;

FIG. 3 is a block diagram illustrating an example of a hardware configuration of an electronic whiteboard, according to an embodiment of the present disclosure;

FIG. 4 is a block diagram illustrating an example of a hardware configuration of multifunction peripheral/product/printer (MFP), according to an embodiment of the present disclosure;

FIG. 5 is a block diagram illustrating an example of a functional configuration of each of the apparatuses and devices of the service integrated system illustrated in FIG. 1;

FIG. 6 is a diagram illustrating an example of service contract information, according to an embodiment of the present disclosure;

FIG. 7 is a diagram illustrating an example of report definition information, according to an embodiment of the present disclosure;

FIG. 8 is a diagram illustrating an example of data definition information, according to an embodiment of the present disclosure;

FIG. 9 is a diagram illustrating an example of aggregation basis information, according to an embodiment of the present disclosure;

FIG. 10 is a flowchart illustrating an example of steps in a report output process, according to an embodiment of the present disclosure;

FIG. 11 is a diagram illustrating an example of a report selection screen, according to an embodiment of the present disclosure;

FIG. 12 is a diagram illustrating an example of an aggregated data selection screen, according to an embodiment of the present disclosure;

FIG. 13 is a diagram illustrating an example of an output result of a report, according to an embodiment of the present disclosure;

FIG. 14 is a diagram illustrating an example of an aggregated data selection screen, according to the first variation or the present disclosure; and

FIG. 15 is a diagram illustrating an example of an aggregated data selection screen, according to the second variation of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of a service integrated system according to the present disclosure are described, with reference to the drawings.

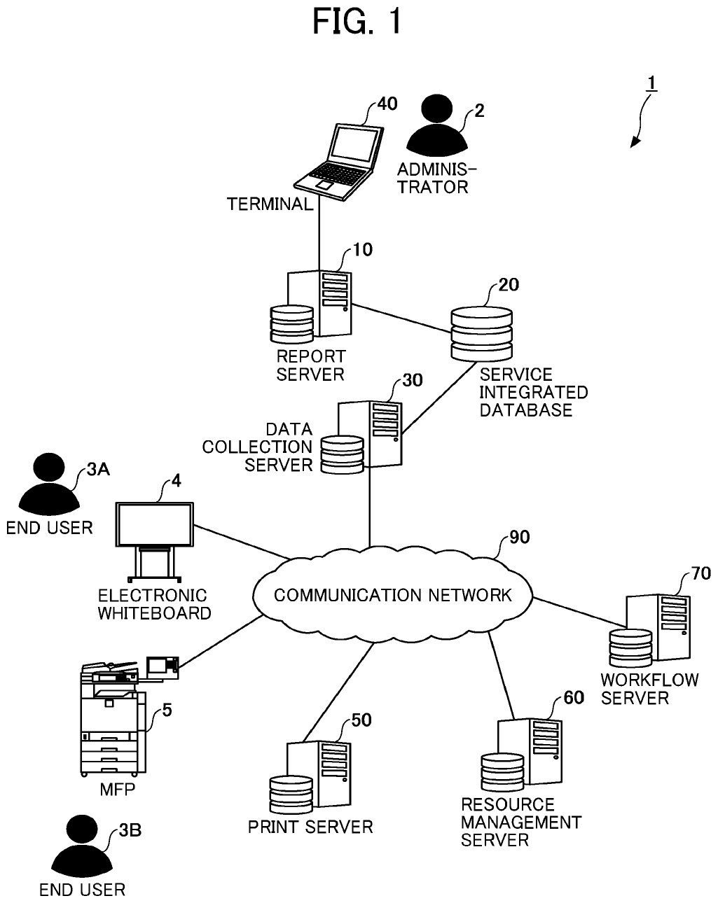

FIG. 1 is a diagram illustrating an example of a configuration of a service integrated system 1.

The service integrated system 1 is a system that integrates a plurality of services. The service integrated system 1 is communicably connected to servers via a communication network 90, the servers providing services respectively, such as a print server 50 that provides a print service, a resource management server 60 that provides a resource management service, and a workflow server 70.

Further, the servers such as the print server 50, the resource management server 60, and the workflow server 70 are communicably connected to devices such as an electronic whiteboard 4 and a multifunction peripheral/product/printer (MFP) 5 via the communication network 90. The electronic whiteboard 4 and the MFP 5 are examples of a device used by users such as an end user 3A and an end user 3B.

When devices such as the electronic whiteboard 4 and the MFP 5 use services respectively, various data are stored in each of the servers. For example, when a user uses a print service provided by the print server 50, data such as the number of printed sheets are accumulated in the print server 50. Further, when a user uses a resource management service provided by the resource management server 60, data such as an occupancy rate of a conference room and a utilization rate of the conference room are accumulated in the resource management server 60.

The service integrated system 1 includes a report server 10, a service integrated database 20, a data collection server 30, and a terminal 40.

The data collection server 30 is communicably connected to servers such as the print server 50, the resource management server 60, and the workflow server 70 via the communication network 90. Further, the data collection server 30 is connected to the service integrated database 20 via a communication line such as a local area network (LAN) line.

The data collection server 30 collects data generated by the usage of a service from each of the servers such as the print server 50, the resource management server 60, and the workflow server 70, and stores the collected data in the service integrated database 20.

The service integrated database 20 is an information storage device, and stores various information to be used by the service integrated system 1.

The report server 10 is an information processing apparatus configured to provide a service (report service) that analyzes data generated by the usage of the various services to outputs a report. The report server 10 is communicably connected to each of the service integrated database 20 and the terminal 40. The report server 10 acquires data from the service integrated database 20 in response to an operation input by an administrator 2 to the terminal 40, and analyzes the acquired data to generate a report. The report server 10 transmits the generated report to the terminal 40.

The terminal 40 is an information processing apparatus configured to receive operations input by the administrator 2. The terminal 40 displays various screens that allows the administrator 2 to input an operation, and transmits information indicating the content of the operation to the input operation to the report server 10.

The administrator 2 is an example of a user who uses the report service provided by the report server 10. For example, the administrator 2 as an individual subscribes to the service. In another example, the administrator 2 is a member of an organization that subscribes to the service. In this case, the organization that subscribes to the service corresponds to a user, and the administrator 2 is a member of the user. The administrator 2 uses the service with an authorization granted to the user. Further, in a case in which the administrator 2, the end user 3A, and the end user 3B belong to the same organization, the administrator 2 is authorized to view a report relating to data that is generated based on the usage of the service by the end user 3A and the end user 3B.

A description is now given of a hardware configuration of each apparatus or device, according to the embodiments of the present disclosure.

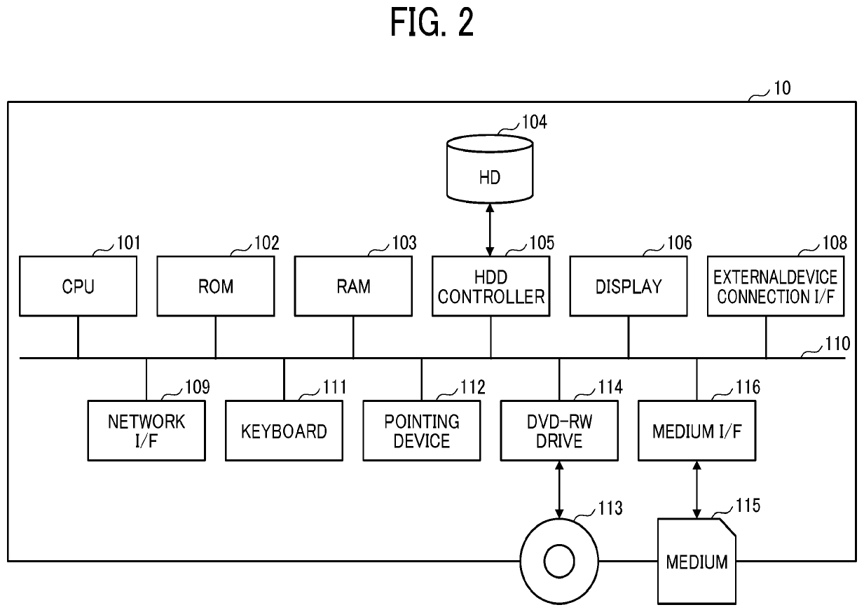

FIG. 2 is a block diagram illustrating an example of a hardware configuration of the report server 10.

The report server 10 is configured as a computer. The report server 10 includes a central processing unit (CPU) 101, a read only memory (ROM) 102, a random access memory (RAM) 103, a hard disk (HD) 104, a hard disk drive (I-MD) controller 105, a display 106, an external device connection interface (I/F) 108, a network I/F 109, a bus line 110, a keyboard 111, a pointing device 112, a digital versatile disk rewritable (DVD-RW) drive 114, and a medium I/F 116.

The CPU 101 controls overall operation of the report server 10. The ROM 102 stores programs such as an initial program loader (IPL) to boot the CPU 101. The RAM 103 is used as a work area for the CPU 101. The HD 104 stores programs such as guest network creation application and various other data. The HDD controller 105 controls reading or writing of various data from or to the HD 104 under control by the CPU 101. The display 106 displays various information such as a cursor, menu, window, characters, or image.

The external device connection I/F 108 is an interface that connects the computer to various extraneous sources. Examples of the extraneous sources include, but not limited to, a universal serial bus (USB) memory and a printer. The network I/F 109 is an interface that allows the computer to perform data communication with other devices such as the service integrated database 20 and the terminal 40. Examples of the bus line 110 include, but not limited to, an address bus and a data bus, which electrically connects the components such as the CPU 101 illustrated in FIG. 2 with each other.

The keyboard 111 is an example of an input device provided with a plurality of keys that allows a user to input characters, numerals, or various instructions. The pointing device 112 is an example of an input device that allows a user to select or execute a specific instruction, select a target for processing, or move a cursor being displayed. The DVD-RW drive 114 controls reading or writing of various data from or to a DVD-RW 113, which is an example of a removable storage medium. The removable storage medium is not limited to the DVD-RW and may be a digital versatile disk-recordable (DVD-R) or the like. The medium I/F 116 controls reading or writing (storing) of data from or to a medium 115 such as a flash memory.

Each of the data collection server 30, the terminal 40, the print server 50, the resource management server 60, and the workflow server 70 is also configured as a computer and has the same or substantially the same hardware configuration as that of the report server 10.

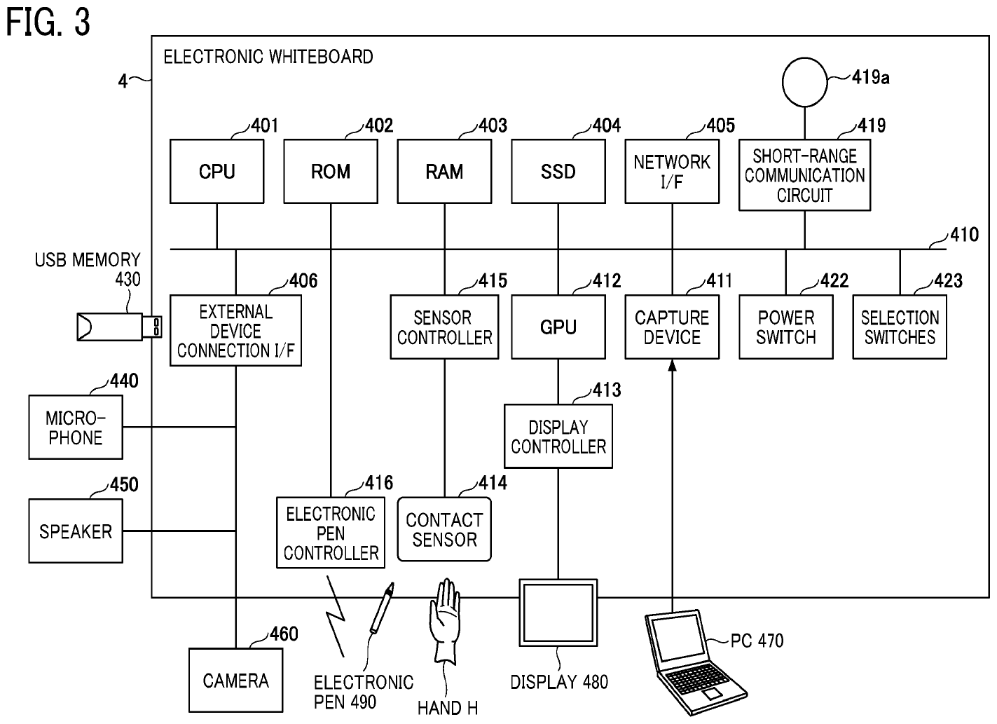

FIG. 3 is a block diagram illustrating an example of a hardware configuration of the electronic whiteboard 4.

The electronic whiteboard 4 includes a CPU 401, a ROM 402, a RAM 403, a solid state drive (SSD) 404, a network I/F 405, and an external device connection I/F 406.

The CPU 401 controls overall operation of the electronic whiteboard 4. The ROM 402 stores programs such as an initial program loader (IPL) to boot the CPU 401. The RAM 403 is used as a work area for the CPU 401. The SSD 404 stores various data such as a control program for the electronic whiteboard 4. The network I/F 405 controls communication with external devices through the communication network 90. The external device connection I/F 406 is an interface that connects the electronic whiteboard 4 to various external devices. Examples of the extraneous sources include, but not limited to, a USB memory 430 and external devices (a microphone 440, a speaker 450, and a camera 460).

The electronic whiteboard 4 further includes a capture device 411, a graphics processing unit (GPU) 412, a display controller 413, a contact sensor 414, a sensor controller 415, an electronic pen controller 416, a short-range communication circuit 419, and an antenna 419a for the short-range communication circuit 419, a power switch 422, and selection switches 423.

The capture device 411 causes a display of an external personal computer (PC) 470 to display a still image or a moving image according video data. The GPU 412 is a semiconductor chip dedicated to processing a graphical image. The display controller 413 controls display of an image processed at the GPU 412 for outputting on a display 480. The contact sensor 414 detects a touch onto the display 480 with an electronic pen 490 or a user's hand H. The sensor controller 415 controls operation of the contact sensor 414. The contact sensor 414 performs input of coordinates and detection of coordinates by an infrared cutoff system. More specifically, the display 480 is provided with two light receiving elements disposed on both upper side ends of the display 480, and a reflector frame surrounding the sides of the display 480. The light receiving elements emit a plurality of infrared rays in parallel to a surface of the display 480. The light receiving elements receive lights passing in the direction that is the same as an optical path of the emitted infrared rays, which are reflected by the reflector frame. The contact sensor 414 outputs an identifier (ID) of the infrared ray that is blocked by an object after being emitted from the light receiving elements, to the sensor controller 415. Based on the ID of the infrared ray, the sensor controller 415 detects a specific coordinate that is touched by the object. The electronic pen controller 416 communicates with the electronic pen 490 to detect contact by the tip or bottom of the electronic pen 490 with the display 480. The short-range communication circuit 419 is a communication circuit that communicates in compliance with the near field communication (NFC), the Bluetooth (Registered Trademark), and the like. The power switch 422 turns on or off the power of the electronic whiteboard 4. The selection switches 423 are a group of switches for adjusting brightness, hue, etc., of display on the display 480, for example.

The electronic whiteboard 4 further includes a bus line 410. Examples of the bus line 410 include, but not limited to, an address bus and a data bus, which electrically connects the components such as the CPU 401 illustrated in FIG. 3 with each other.

The contact sensor 414 is not limited to the infrared blocking system type, and may be a different type of detector, such as a capacitance touch panel that identifies the contact position by detecting a change in capacitance, a resistance film touch panel that identifies the contact position by detecting a change in voltage of two opposed resistance films, or an electromagnetic induction touch panel that identifies the contact position by detecting electromagnetic induction caused by contact of an object to a display. In addition to or in alternative to detecting a touch by the tip or bottom of the electronic pen 490, the electronic pen controller 416 may also detect a touch by another part of the electronic pen 490, such as a part held by a hand of the user.

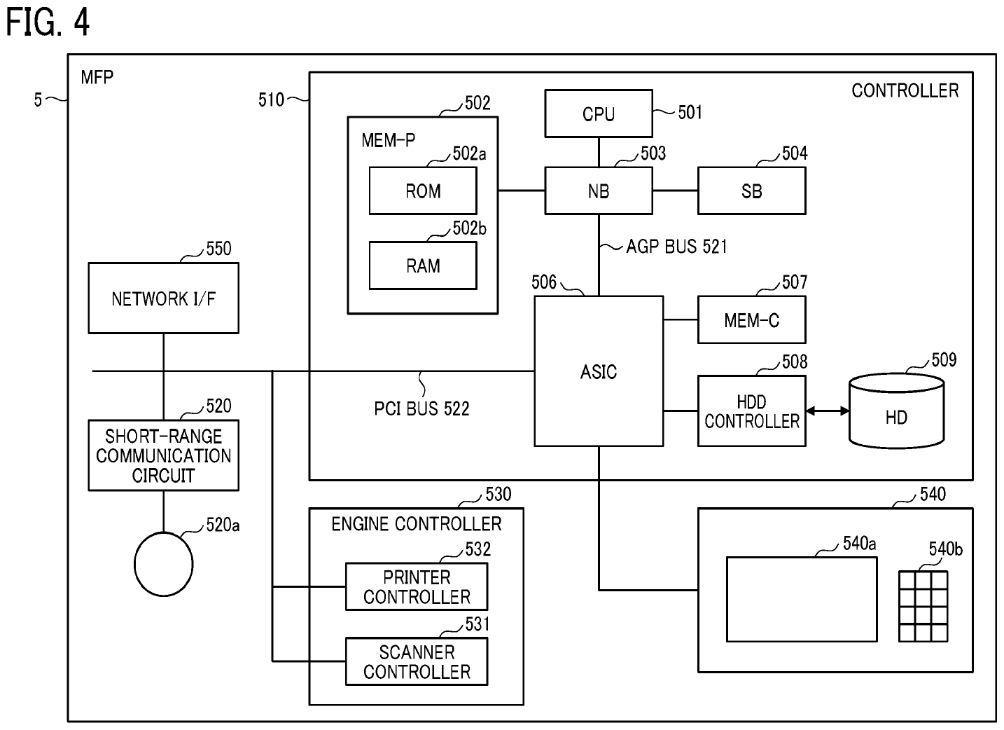

FIG. 4 is a block diagram illustrating an example of a hardware configuration of the MFP 5.

FIG. 4 is a diagram illustrating a hardware configuration of the MFP 5. As illustrated in FIG. 4, the MFP 5 includes a controller 510, a short-range communication circuit 520, an engine controller 530, a control panel 540, and a network I/F 550.

The controller 510 includes a CPU 501 as a main processor of the MFP, a system memory (MEM-P) 502, a north bridge (NB) 503, a south bridge (SB) 504, an application specific integrated circuit (ASIC) 506, a local memory (MEM-C) 507 as a storage unit, an HDD controller 508, and an HD 509 as a storage unit. The NB 503 and the ASIC 506 are connected through an Accelerated Graphics Port (AGP) bus 521.

The CPU 501 controls overall operation of the MFP 5. The NB 503 connects the CPU 501 with the MEM-P 502, the SB 504, and the AGP bus 521. The NB 503 includes a memory controller for controlling reading or writing of various data with respect to the MEM-P 502, a Peripheral Component Interconnect (PCI) master, and an AGP target.

The MEM-P 502 includes a ROM 502a as a memory that stores program and data for implementing various functions of the controller 510. The MEM-P 502 further includes a RAM 502b as a memory that deploys the program and data, or as a drawing memory that stores drawing data for printing. The program stored in the ROM 502a may be stored in any computer-readable storage medium, such as a compact disk-read only memory (CD-ROM), compact disk-recordable (CD-R), or DVD, in a file format installable or executable by a computer, for distribution.

The SB 504 is a bridge to connect the NB 503 to a PCI device and a peripheral device. The ASIC 506 is an integrated circuit (IC) dedicated to an image processing use, and has a function of a bridge to connect the AGP bus 521, a PCI bus 522, the HDD controller 508, and the MEM-C 507 to each other. The ASIC 506 includes a PCI target, an AGP master, an arbiter (ARB) as a central processor of the ASIC 506, a memory controller, a plurality of direct memory access controllers (DMACs), and a PCI unit. The memory controller controls the MEM-C 507. The DMACs is capable of converting coordinates of image data with a hardware logic. The PCI unit transfers data between a scanner controller 531 and a printer controller 532 through the PCI bus 522. The ASIC 506 can be connected to a USB interface, or the Institute of Electrical and Electronics Engineers 1394 (IEEE1394) interface.

The MEM-C 507 is a local memory used as a buffer for image data to be copied or a code buffer. The HD 509 stores various image data, font data for printing, and form data. The HDD controller 508 controls reading or writing of various data from or to the HD 509 under control by the CPU 501. The AGP bus 521 is a bus interface for a graphics accelerator card, which has been proposed to accelerate graphics processing. Through directly accessing the MEM-P 502 by high-throughput, speed of the graphics accelerator card is improved.

The short-range communication circuit 520 is provided with an antenna 520a. The short-range communication circuit 520 is a communication circuit that communicates in compliance with, for example, an NFC or the Bluetooth.

The engine controller 530 includes the scanner controller 531 and the printer controller 532. The control panel 540 includes a panel display 540a and an operation panel 540b. The panel display 540a is implemented by, for example, a touch panel that displays current settings or a selection screen to receive a user input. The operation panel 540b includes a numeric keypad that receives set values of various image forming parameters such as image density parameter and a start key that receives an instruction for starting copying. The controller 510 controls overall operation of the MFP 5. For example, the controller 510 controls drawing, communication, or user inputs to the control panel 540. The scanner controller 531 and the printer controller 532 each performs various image processing, such as error diffusion or gamma conversion.

In response to an instruction to select a specific application through the control panel 540, for example, using a mode switch key, the MFP 5 selectively performs a document box function, a copier function, a printer function, and a facsimile function. When the document box function is selected, the MFP 5 operates in a document box mode. When the copier function is selected, the MFP 5 operates in a copy mode. When the printer function is selected, the MFP 5 operates in a printer mode. When the facsimile function is selected, the MFP 5 operates in a facsimile mode.

The network I/F 550 is an interface that allows the MFP 5 to perform data communication through the communication network 90. The short-range communication circuit 520 and the network I/F 550 are electrically connected to the ASIC 506 through the PCI bus 522.

A description is now given of functions of each of the apparatuses and devices.

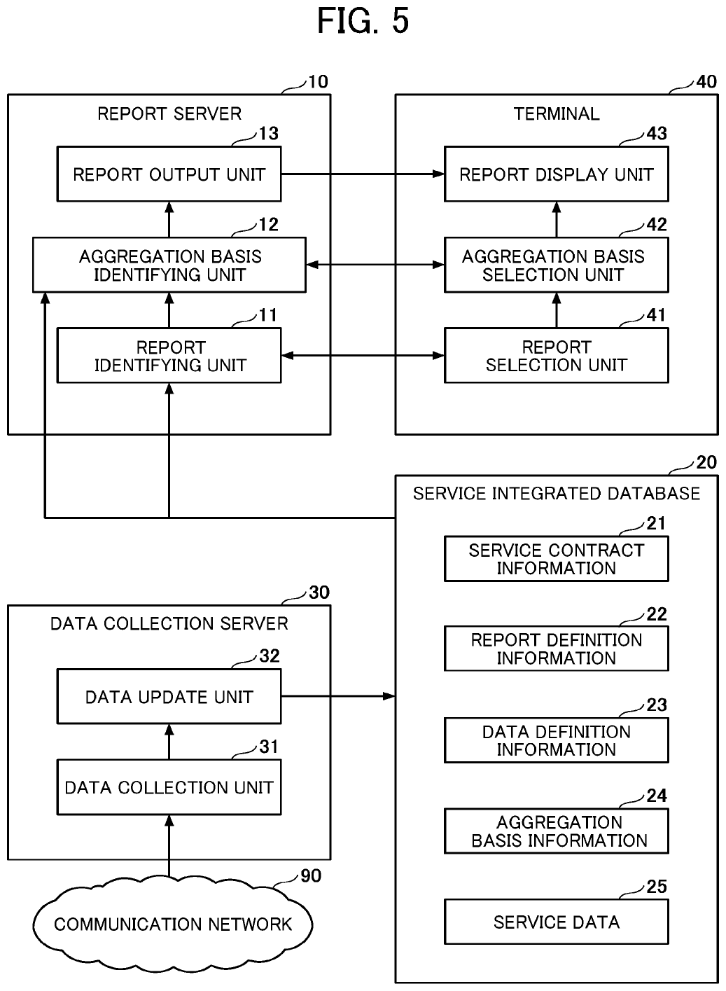

FIG. 5 is a block diagram illustrating an example of a functional configuration of each of the apparatuses and devices of the service integrated system 1.

The data collection server 30 includes a data collection unit 31 and a data update unit 32.

The data collection unit 31 collects data generated by the usage of the service from each of the servers that provides services respectively via the communication network 90.

The data update unit 32 updates service data 25 stored in the service integrated database 20 to the data collected by the data collection unit 31.

The service integrated database 20 stores service contract information 21, report definition information 22, data definition information 23, aggregation basis information 24, and the service data 25.

The service contract information 21, the report definition information 22, the data definition information 23, and the aggregation basis information 24 are information required for an operation performed by the report server 10. A detailed description is given below of specific examples of the above information items.

The service data 25 is data generated by the usage of the various services. The service data 25 includes attribute information such as a user, a device, a service, and a date and time. For example, data of the number of printed sheets, which is data obtained by the usage of the print service, is associated with the attribute information such as a user who has used the print service, a device, a service indicating the print service, and a print date and time.

Further, the service data 25 of a user who has used a plurality of services is associated with the attribute information relating to the plurality of services. For example, data of the number of printed sheets, which is data obtained by the usage of the print service and a device management service, is associated with the attribute information including the device. Therefore, the number of printed sheets for each device can be aggregated based on such data.

The report server 10 includes a report identifying unit 11, an aggregation basis identifying unit 12, and a report output unit 13.

The report identifying unit 11 identifies one or more reports available to the user based on the service contract information 21 and the report definition information 22.

The aggregation basis identifying unit 12 identifies a data item as a basis (an aggregation basis) for the aggregation of a report to be output, based on the aggregation basis information 24, from data available to the user, which data is identified based on the service contract information 21 and the data definition information 23.

The report output unit 13 outputs the report aggregated based on the data identified by the aggregation basis identifying unit 12.

The terminal 40 includes a report selection unit 41, an aggregation basis selection unit 42, and a report display unit 43.

The report selection unit 41 selects a report in response to a user operation. Specifically, the report selection unit 41 receives a selection by the user from the one or more reports identified by the report identifying unit 11 of the report server 10.

The aggregation basis selection unit 42 selects the data item (aggregation basis) in response to a user operation. Specifically, the aggregation basis selection unit 42 receives a selection by the user of the data item as the basis for the aggregation identified by the aggregation basis identifying unit 12 of the report server 10.

The report display unit 43 displays the report output from the report output unit 13 of the report server 10.

A description is now given of the information handled by the service integrated system 1.

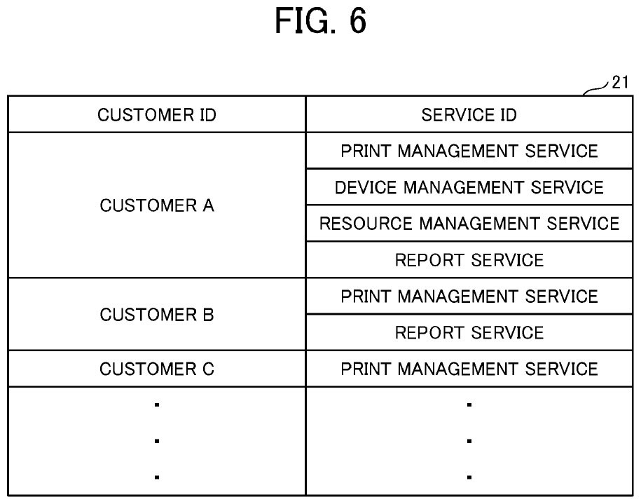

FIG. 6 is a diagram illustrating an example of the service contract information 21. The service contract information 21 is an example of information indicating one or more services available to a user. Specifically, the service contract information 21 indicates one or more services that the user is authorized to use by the user's subscription to a service provider. The service contract information 21 includes a customer identifier (ID) and a service ID as items.

The value of the item “customer ID” is an identifier identifying a particular customer. The customer is an example of a user. The customer can be either an organization or an individual.

The value of the item “service ID” is an identifier identifying a particular service. The value of the item “service ID” indicates that the service is available to the customer identified by the customer ID.

For example, according to FIG. 6, Customer A subscribes to a print management service, the device management service, the resource management service, and the report service, and Customer A is authorized to these services. Further, according to FIG. 6, Customer B is authorized to use the print management service and the report service, and Customer C is authorized to the print management service.

Since the subscription to the report service is required to output a report, the report server 10 does not output any report to Customer C. Further, the report server 10 can output reports of the print management service, the device management service, and the resource management service to Customer A. Furthermore, the report server 10 can output a report of the print management service to Customer B.

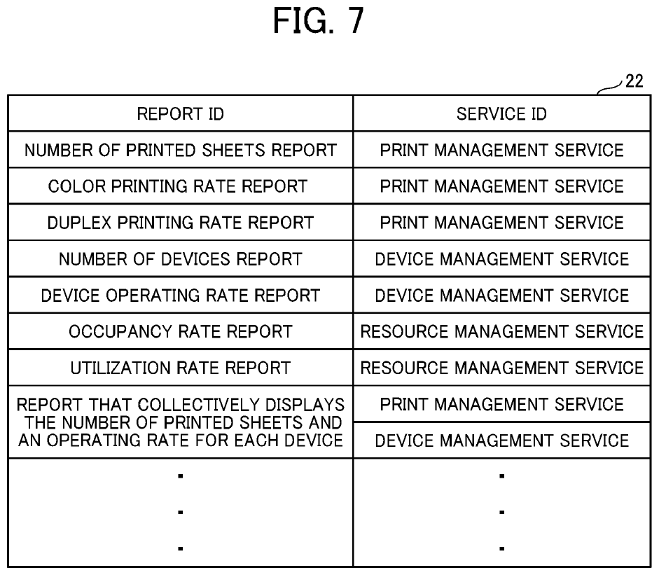

FIG. 7 is a diagram illustrating an example of the report definition information 22.

The report definition information 22 is information indicating a definition of each report. The report definition information 22 defines a service to which the customer should subscribes to have a report to be output. The report definition information 22 includes a report ID and a service ID as items.

The value of the item “report ID” is an identifier identifying a particular report. For each report, data to be analyzed, how to analyze the data, how to output the report, etc., are defined in advance.

The value of the item “service ID” is an identifier identifying a particular service. Either one or two or more values can be set to the item “service ID”. When two or more values are set, the subscriptions to all of two or more services corresponding to the values are required.

For example, FIG. 7 indicates that the report server 10 outputs a number of printed sheets report, a color printing rate report, and a duplex printing rate report to a user who subscribes to the print management service.

Further, as indicated in FIG. 7, when the value of the item “report ID” is a “report that collectively displays the number of printed sheets and an operating rate for each device”, and the value of the record item “service ID” is the “print management service” and the “device management service”, the subscriptions to the print management service and the device management service are required to output the “report that collectively displays the number of printed sheets and an operating rate for each device”.

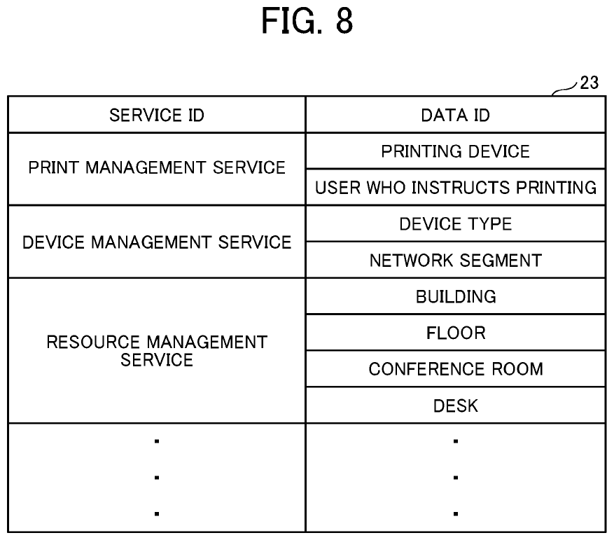

FIG. 8 is a diagram illustrating an example of the data definition information.

The data definition information 23 is information indicating data generated for each service. The data definition information 23 includes the service ID and a data ID as items.

The value of the item “service ID” is an identifier identifying a particular service.

The value of the item “data ID” is an identifier identifying particular data. Either one or two or more values can be set to the item “service ID”. When two or more values are set, all of two or more data items corresponding to the values are generated by the usage of one service.

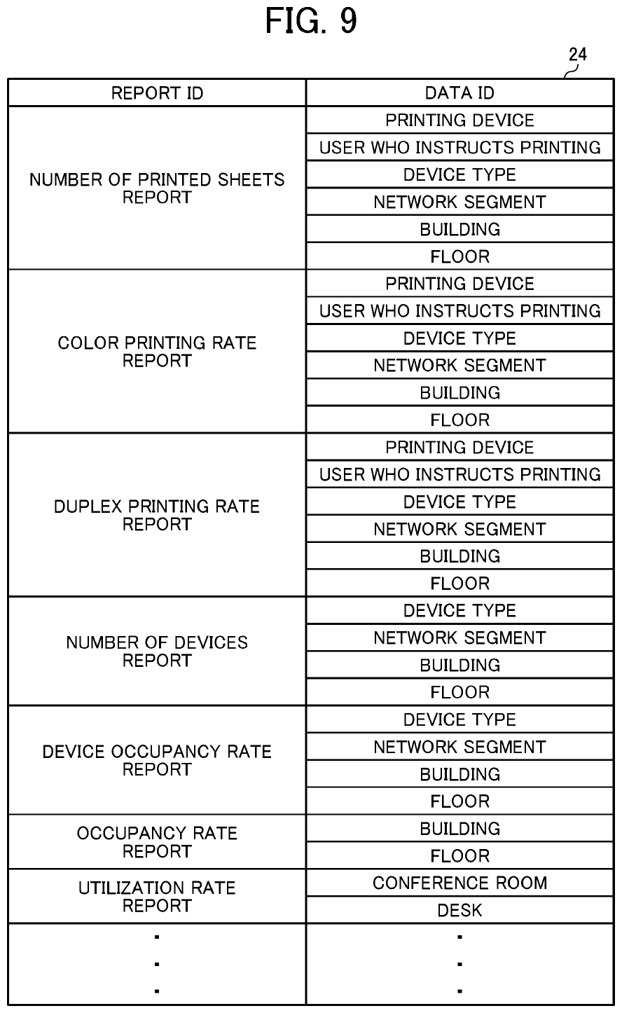

FIG. 9 is a diagram illustrating an example of the aggregation basis information 24. The aggregation basis information 24 is information indicating data items, each being usable as a basis to aggregate data to be included in a report. The aggregation basis information 24 includes the report ID and the data ID as items.

The value of the item “report ID” is an identifier identifying a particular report.

The value of the item “data ID” is an identifier identifying particular data. Specifically, the value of the item “data ID” indicates data usable as a basis based on which data to be included in each report is aggregated.

Either one or two or more values can be set to the item “data ID”. When two or more values are set, the administrator 2 can select any one of two or more data items corresponding to the two or more values.

For example, as illustrated in FIG. 9, the values of the item “data ID” associated with the value “number of printed sheets” of the item “Report ID” is a “printing device”, “user who instructs printing”, “device type”, “network segment”, “building” and “floor”, the administrator 2 can select any one of the “printing device”, “user who instructs printing”, “device type”, “network segment”, “building” and “floor” as a basis based on which the number of printed sheets, which is data to be included in the report of the “number of printed sheets”, is to be aggregated.

Although the description given above is of an example in which the value of the ID item of each information is character strings, in another example, the value is configured by a particular character type such as numbers or alphabets.

A description is now given of an operation performed by the service integrated system 1.

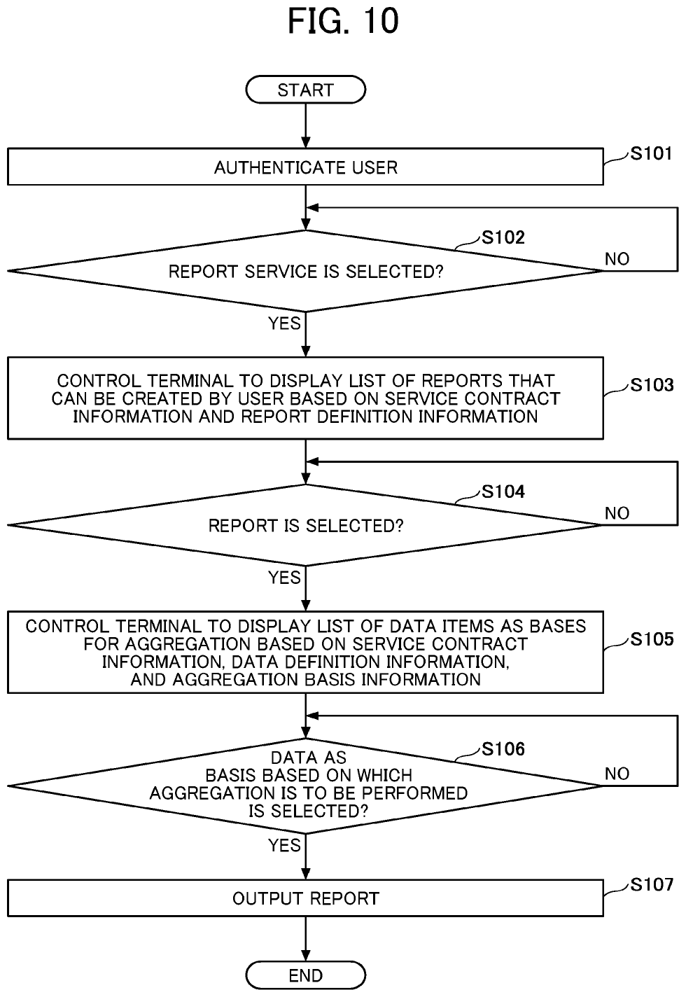

FIG. 10 is a flowchart illustrating an example of steps in a report output process. The report output process is started in response to an operation to the terminal 40 by the administrator 2 who subscribes to the report service.

The report server 10 authenticates a user (step S101) Specifically, the report server 10 uses a login authentication function to authenticate an account of an administrator who operates the terminal 40. For example, the report server 10 prompts the administrator 2 to enter a user ID and a password, and determines whether the entered user ID and password match information registered by the user who subscribes the report service. When the authentication is successful, the report server 10 grants authorization as a user to the administrator 2 operating the terminal 40.

In response to an operation of selecting the report service by the administrator 2 who is granted the authorization as the user who subscribes to the report service, the terminal 40 transmits information indicating a selection result to the report server 10.

In response to receiving the information from the terminal 40, the report server 10 determines whether the report service is selected (step S102). When the report server 10 determines that the report service is not selected (step S102: NO), the report server 10 repeats the process of step S102 until the information is transmitted from the terminal 40.

When the report server 10 determines that the report service is selected (step S102: YES), the report identifying unit 11 controls the terminal 40 to display a list of reports that can be created by the user based on the service contract information 21 and the report definition information 22 (step S103).

Specifically, the report identifying unit 11 identifies one or more services to which the administrator 2 as the user subscribes based on the service contract information 21, and identifies one or more reports that requires the identified subscribed service(s) based on the report definition information 22. The identified one or more reports are a report or reports available to the user.

The report selection unit 41 of the terminal 40 displays a report selection screen 1000. A detailed description is given below of a specific example of the report selection screen 1000. In response to receiving a selection by the administrator 2, the report selection unit 41 transmits information indicating the selection result to the report server 10.

The report identifying unit 11 of the report server 10 determines whether a particular report is selected (step S104). When the report identifying unit 11 determines that any report is not selected (step S104: NO), the report identifying unit 11 repeats the process of step S104 until the information is transmitted from the terminal 40.

When the report identifying unit 11 determines that a particular report is selected (step S104: YES), the aggregation basis identifying unit 12 controls the terminal 40 to display a list of data items usable as bases for aggregation based on the service contract information 21, the data definition information 23, and the aggregation basis information 24 (step S105). Specifically, the aggregation basis identifying unit 12 identifies data items usable as bases for aggregation of the selected report based on the aggregation basis information 24, identifies one or more services to which the administrator 2 as the user subscribes based on the service contract information 21 among the data items identified as bases for aggregation of the selected report, and identifies data generated by the use of the identified one or more services based on the data definition information 23. The aggregation basis identifying unit 12 transmits information indicating the data identified as above to the terminal 40.

The aggregation basis selection unit 42 of the terminal 40 displays a list of the received data as an aggregated data selection screen. A detailed description is given below of a specific example of the aggregated data selection screen. In response to receiving a selection by the administrator 2, the aggregation basis selection unit 42 transmits information indicating the selection result to the report server 10.

The aggregation basis identifying unit 12 of the report server 10 determines whether a particular data item as the basis for aggregation is selected (step S106). When the aggregation basis identifying unit 12 determines that any data item as the basis for aggregation is not selected (step S106: NO), the aggregation basis identifying unit 12 repeats the process of step S106 until the information is transmitted from the terminal 40.

When the aggregation basis identifying unit 12 determines that the particular data item as the basis for aggregation is selected (step S106: YES), the report output unit 13 outputs a report (step S107). Specifically, the report output unit 13 analyzes the data by an analysis method defined for the selected report, and aggregates data based on the data items selected as the basis for aggregation to generate a report. Then, the report output unit 13 transmits information indicating the generated report to the terminal 40.

The report display unit 43 of the terminal 40 displays the received report. Further, the terminal 40 may store the received report as an electronic file or print the report on a print medium such as a sheet of paper. A detailed description is given below of a specific example of an output result 1200 of the report.

The operation of outputting the report described above is just an example, and the report server 10 can perform the processes in a different order. For example, in a case of a so-called What You See Is What You Get (WYSIWYG) report creation method according to which report widgets are placed on a dashboard-type graphical user interface (GUI) by a drag-and-drop operation using a mouse, the information items may be read at the time of login to the system and cached in the memory.

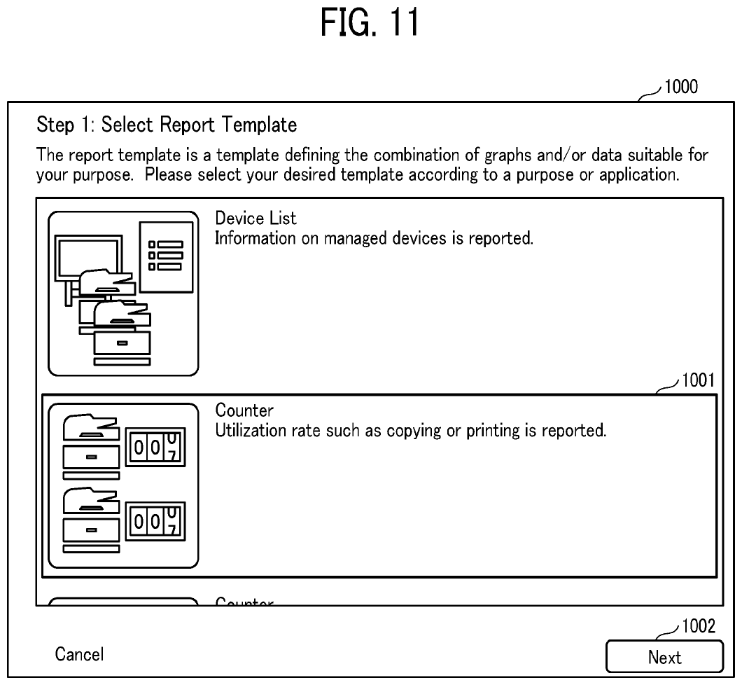

FIG. 11 is a diagram illustrating an example of the report selection screen 1000.

The report selection screen 1000, which is displayed on the terminal 40 at the process of step S103 in the operation of outputting the report, includes a report selection field 1001 and an enter button 1002.

The report selection field 1001 includes a list of reports that can be output in one or more services to which the authenticated user subscribes, and receives a selection from the user.

In response to pressing of the enter button 1002, information indicating a content of the selection in the report selection field 1001 is transmitted to the report server 10.

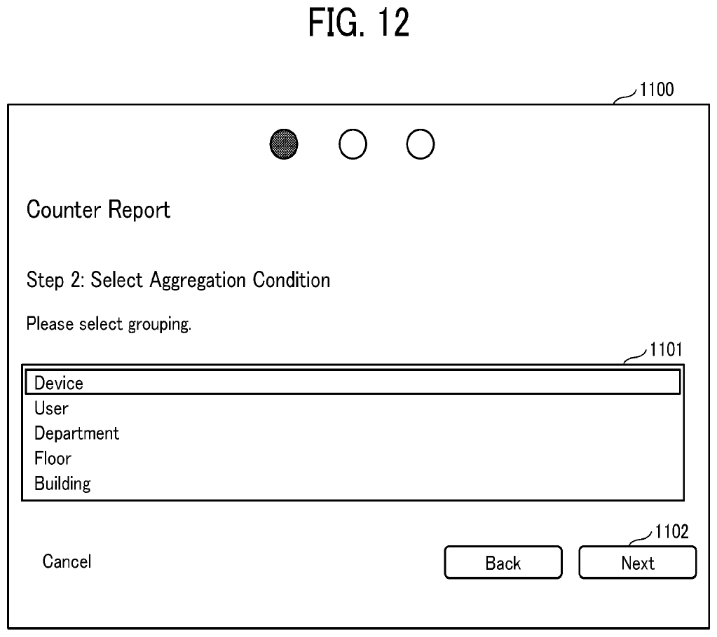

FIG. 12 is a diagram illustrating an example of an aggregated data selection screen 1100.

The aggregated data selection screen 1100, which is displayed on the terminal 40 at the process of step S105 in the operation of outputting the report, includes a data selection field 1101 and an enter button 1102.

The data selection field 1101 displays a list of data items that can be used as bases for aggregation in one or more services to which the authenticated user subscribes, and receives a selection from the user.

In response to pressing of the enter button 1102, information indicating a content of the selection in the data selection field 1101 is transmitted to the report server 10.

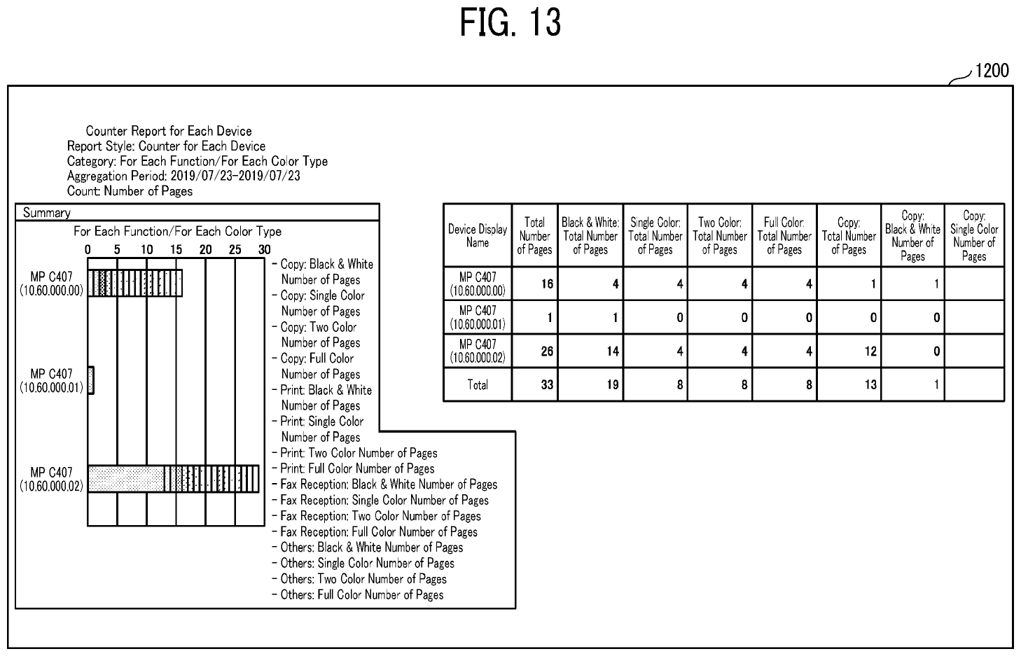

FIG. 13 is a diagram illustrating an example of the output result 1200 of the report. The output result 1200 includes information in which data defined as the report are aggregated for each data item as a basis for aggregation. For example, FIG. 13 illustrates the result that is output when the selection indicates that a report in which the number of printed sheets is displayed for each function and each color type is aggregated for each device.

According to the service integrated system 1 according to the present embodiment, data to be combined for target data of the report is limited to data generated by the use of the service available to the user. Thus, the service integrated system 1 improves an added value provided to a user through the report service when the user subscribes to plural services.

First Variation: In the above-described embodiment, a plurality of data items can be selected as the aggregated data.

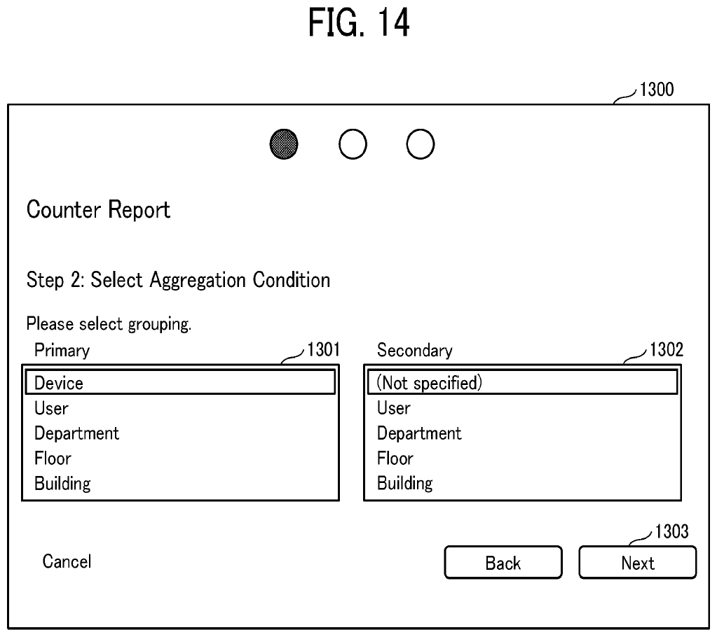

FIG. 14 is a diagram illustrating an example of an aggregated data selection screen 1300, according to the first variation.

The aggregated data selection screen 1300, which is displayed on the terminal 40 at the process of step S105 in the operation of outputting the report according to the present variation, includes a first data selection field 1301, a second data selection field 1302, and an enter button 1303.

Further, in step S107 of the operation of outputting the report according to the present variation, the report output unit 13 performs cross tabulation using two data items selected in the first data selection field 1301 and the second data selection field 1302, to generate a report.

The service integrated system 1 according to the present variation prompts the user to select a plurality of data items to be combined with respect to the target data of the report, and performs cross tabulation using the selected plurality of data items. Thus, the service integrated system 1 implements data analysis from more diversified perspectives, and further improves an added value provided to a user through the report service when the user subscribes to plural services.

Second Variation:

In the above-described embodiment, the terminal 40 can display information indicating a service to be purchased in order to use the data indicated in the aggregation basis information.

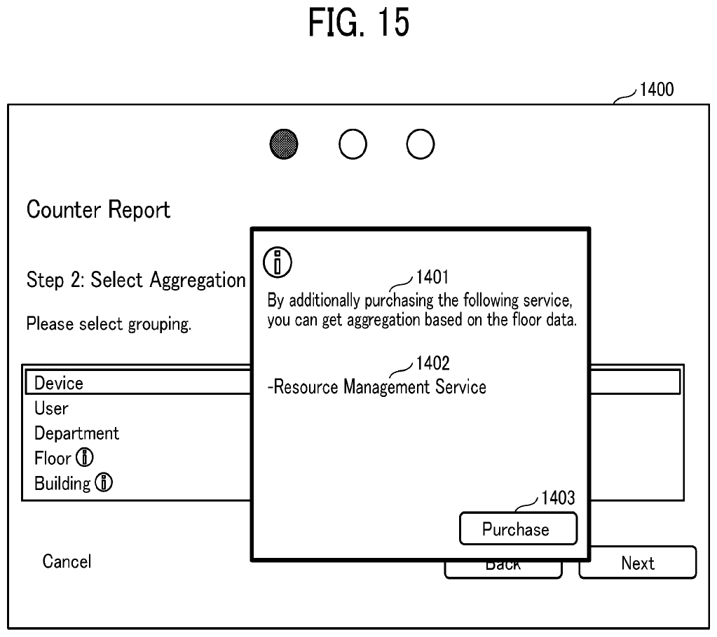

FIG. 15 is a diagram illustrating an example of an aggregated data selection screen 1400, according to the second variation.

The aggregated data selection screen 1400, which is displayed on the terminal 40 at the process of step S105 in the operation of outputting the report according to the present variation, includes an aggregated data display field 1401, a to-be-added service display field 1402, and a purchase button 1403.

Indicated in the aggregated data display field 1401 is a data item usable as a basis for aggregation of a service to which the authenticated user does not subscribe.

In the to-be-added service display field 1402, a service to be subscribed to enable the data item displayed in the aggregated data display field 1401 to be used as a basis for aggregation is displayed.

In response to pressing of the purchase button 1403, the current screen transitions to a screen that allows a user to subscribe to the service displayed in the to-be-added service display field 1402.

The service integrated system 1 according to the present variation presents information indicating which data item can be combined for analysis and which service is to be additionally purchased to create a report using the data item. This provides a service seller with an opportunity for an upsell. Further, this makes it easy for a user to recognize which service is to be additionally purchased when he or she wants to perform particular data analysis.

When providing a service that integrates a plurality of services, various types of data generated for each service that is used are accumulated. There is a demand to output a more value-added report to a user who subscribes to plural services by combining data relevant to the plural services.

However, it is difficult to limit data to be combined with target data of the report to data generated by the use of the services available to the user. Therefore, the added value to be provided when plural services are subscribed is not sufficient.

According to one or more embodiments, an added value that is provided by subscriptions of plural services is improved.

The apparatuses or devices described in each embodiment are merely one example of plural computing environments that implement one or more embodiments disclosed herein. In some embodiments, the report server 10 includes plural computing devices, such as a server cluster. The plural computing devices are configured to communicate with one another through any type of communication link, including a network, shared memory, etc., and perform the processes described in this disclosure. Further, the service integrated system 1 may be implemented by a single device or apparatus.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

Further, in the embodiments, the description given above is of an example in which the terminal 40 is implemented by an information processing apparatus. The information processing apparatus is just one example of the terminal 40, and the terminal 40 can be implemented by any suitable device or apparatus, provided that it has a communication capability. Other examples of the terminal 40 include an output device such as a projector (PJ) and a digital signage, a head-up display (HUD), an industrial machine, a medical device, a networked home appliance, an automobile (connected car), a laptop computer, a mobile phone, a tablet terminal, a game console, a personal digital assistant (PDA), a digital camera, a wearable PC, and a desktop PC.

Further, the description given above is of an example in which the device is implemented by the electronic whiteboard 4 and the MFP 5. Each of the electronic whiteboard and the MFP is just one example of the device, and the device can be implemented by any suitable device or apparatus, provided that it has a communication capability. Other examples of the device include an output device such as a projector (PJ) and a digital signage, a head-up display (HUD), an industrial machine, a medical device, a networked home appliance, an automobile (connected car), a laptop computer, a mobile phone, a tablet terminal, a game console, a personal digital assistant (PDA), a digital camera, a wearable PC, and a desktop PC.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

1. An information processing apparatus comprising circuitry configured to:
identify a particular data item as a basis for aggregation of a report to be output, based on aggregation basis information that indicates one or more data items usable as bases for aggregating data to be contained in the report, among data available to a user, the data available to the user being identified based on service contract information that indicates one or more services available to the user and data definition information that indicates data generated for each of the one or more services; and
output the report aggregated using the identified particular data item as the basis.

2. The information processing apparatus of claim 1, wherein
the circuitry is further configured to:
identify a particular report available to the user based on the service contract information and report definition information that defines, for each of one or more reports, a service to be subscribed;
identify the particular data item as the basis for aggregation of the identified particular report; and
output the identified particular report.

3. The information processing apparatus of claim 2, wherein
the report definition information includes a report that requires subscriptions to a plurality of services including at least any one of the one or more services.

4. The information processing apparatus of claim 1, wherein
the circuitry is further configured to:
identify a plurality of particular data items as bases for aggregation of the report to be output, based on the aggregation basis information, among a plurality of data items including the one or more data items, the plurality of data items being identified based on the service contract information and the data definition information; and
output the report aggregated using the identified plurality of particular data items as bases.

5. The information processing apparatus of claim 1, wherein
the circuitry is further configured to control a terminal operated by the user to display information indicating a service to be subscribed to enable a usage of the one or more data items indicated by the aggregation basis information, based on the service contract information and the data definition information.

6. A service integrated system comprising:
a terminal including first circuitry; and
an information processing apparatus including second circuitry,
the first circuitry being configured to
select a data item in response to a user operation, and
display a report output from the information processing apparatus,
the second circuitry being configured to
cause the first circuitry of the terminal to select the a data item based on aggregation basis information that indicates one or more data items usable as bases for aggregating data to be contained in the report, among data available to a user, the data available to the user being identified based on service contract information that indicates one or more services available to the user and data definition information that indicates data generated for each of the one or more services,
identify the selected data item as a particular data item as a basis for aggregation of the report to be output, and
output to the terminal the report aggregated using the identified particular data item as the basis.

7. A non-transitory computer-executable medium storing a program storing instructions which, when executed by a computer, causes the computer to:
identify a particular data item as a basis for aggregation of a report to be output, based on aggregation basis information that indicates one or more data items usable as bases for aggregating data to be contained in the report, among data available to a user, the data available to the user being identified based on service contract information that indicates one or more services available to the user and data definition information that indicates data generated for each of the one or more services; and
output the report aggregated using the identified particular data item as the basis.
